(19) United States
(12) Patent Application Publication
(10) Pub. No.: US 2007/0271378 A1
(43) Pub. Date: Nov. 22, 2007

(54) Storage Driver, Electronic Device, and Access Control Method

(75) Inventor: Kazuyoshi UTSUMI, Okaya-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/749,661

(22) Filed: May 16, 2007

(30) Foreign Application Priority Data
May 19, 2006 (JP) 2006-139727
Apr. 3, 2007 (JP) 2007-097186

(51) Int. Cl. G06F 15/173

(52) U.S. Cl. 709/225

(57) ABSTRACT

A storage driver for controlling access to a storage unit having a password-type lock function checks, when executing processing for erasing all data stored in the storage unit, whether or not a password has been set for the storage unit, and invalidates the password-type lock function if a password has been set.

### CROSS-REFERENCES TO RELATED APPLICATIONS

The entire disclosure of Japanese Patent Application No. 2006-139727, filed on May 19, 2006, and No. 2007-97186, filed on Apr. 3, 2007, is expressly incorporated herein by reference.

### BACKGROUND

1. Technical Field

The present invention relates to a storage driver for controlling access to a storage unit having a password-type lock function, more particularly to an electronic device, such as a printer, having the storage driver.

2. Related Art

Recently, not only personal computers (PCs) but also electronic devices such as printers have large-capacity, nonvolatile storage units represented by a hard disk drive unit (hereinafter referred to as ‘HDD unit’), and the numbers of those kinds of devices are increasing.

There are several standards for storage units. Among them, the ATA (AT Attachment) standard adopts a function for restricting (locking) access to the storage unit by setting a password (hereinafter referred to as ‘password-type lock function’) (see JP-A-2006-59025).

Generally, a storage unit in an electronic device is disposed together when the main body of the electronic device is disposed in many cases. Meanwhile, a storage unit that conforms to the same standard (for example, ATA) as that of a storage unit attached to another electronic device may also be able to be used in that electronic device, regardless of the type of the electronic device. In fact, quite a lot of users want to recycle ‘used’ storage units in other electronic devices.

If a storage unit that has been attached to an electronic device is used in another device, data stored in the storage unit has to be erased before using it in the other device, to prevent the data from ‘leaking’ into the other device.

However, if a password has been set for the storage unit using the above mentioned password-type lock function, erasure of data stored in the storage unit alone is not enough. In order to make the storage unit accessible in another device, it is necessary to invalidate the password-type lock function by using the BIOS, etc., or to notify the other device of the password that has been already set for the storage unit.

Operations for invalidating the password-type lock function using the BIOS, etc. are complicated for users. Actually, it is highly unlikely that many users know that the password-type lock function can be invalidated by using the BIOS, etc. There are many security issues with methods for notifying passwords that have to be kept confidential to other devices.

### SUMMARY

An advantage of some aspects of the invention is the provision of a new technique with which, even if a password has been set for a storage unit that has been attached to an electronic device, the status of the storage unit can easily be changed so that the storage unit can be used in another electronic device without having a user execute operations for invalidating the password-type lock function by using the BIOS, etc.

A storage driver according to an aspect of the invention is a storage driver for controlling access to a storage unit having a password-type lock function. When executing processing for erasing all data that has been stored in the storage unit, the storage driver checks whether or not a password has been set for the storage unit, and invalidates the password-type lock function if a password has been set.

Preferably, the storage driver invalidates the password-type lock function after notifying the storage unit of the set password.

With that configuration, the status of a storage unit that has been attached to an electronic device can be automatically changed so that the storage unit can be used in another electronic device (changed to the state in which the password-type lock function is invalidated) simply by ordering the storage unit to erase all data stored in the storage unit, without executing operations for invalidating the password-type lock function by using the BIOS, etc.

An electronic device according to an aspect of the invention includes a storage driver according to an aspect of the invention and a memory unit for storing device information about the electronic device. In the electronic device, the storage driver creates a password based on the device information acquired by referring to the memory unit, and notifies the storage unit of the created password to set/cancel the password-type lock, or invalidate the password-type lock function.

An access control method according to an aspect of the invention is an access control method for a storage unit having a password-type lock function. The access control method includes checking, when executing processing for erasing all data stored in the storage unit, whether or not a password has been set for the storage unit, and invalidating the password-type lock function if a password has been set.

The access control method according to an aspect of the invention can be implemented by an information processing unit (computer) in the electronic device, and a program for the implementation can be installed or loaded via various media such as a CD-ROM, magnetic disk, semiconductor memory, or communication network. If a printer is assumed as the electronic device, the program may be distributed stored in a printer card or a printer option board.

The invention can provide a new technique with which, even if a password has been set for a storage unit that has been attached to an electronic device, the status of the storage unit can easily be changed so that the storage unit can be used in another electronic device without having a user to execute operations for invalidating the password-type lock function by using the BIOS, etc.

### BRIEF DESCRIPTION OF THE DRAWINGS

FIG. 1 is a block diagram showing the schematic configuration of a printer system according to an embodiment of the invention.

FIG. 2 is a block diagram showing the functional configuration of an information processing unit in a printer device 20.

FIG. 3 is a flowchart defining operations in a HDD driver 22.

### DESCRIPTION OF EXEMPLARY EMBODIMENTS

An embodiment of the invention will be described below with reference to the drawings.

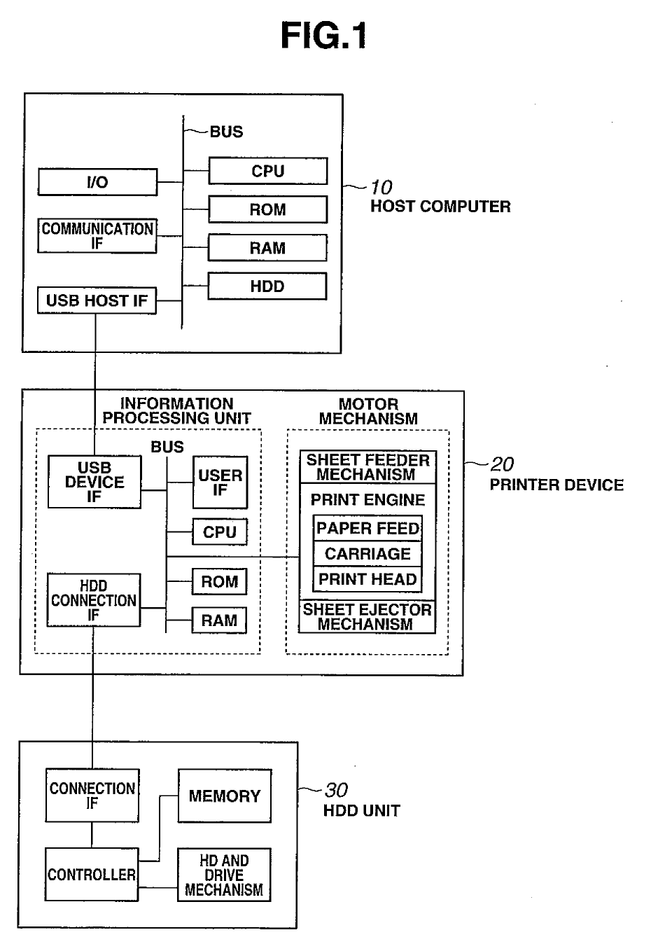

FIG. 1 is a block diagram showing the schematic configuration for a printer system according to an embodiment of the invention. As shown in FIG. 1, a host computer 10 is connected, via a USB (Universal Serial Bus) interface, to a printer device 20. The printer device 20 is configured to be capable of accessing a HDD unit 30 via a predetermined interface. The standard the predetermined interface conforms to is not limited to any particular one, so long as the standard supports a password-type lock function. The following description explains an example of the ATA.

Although the HDD unit 30 is outside the printer device 20 in FIG. 1, the printer device 20 may include the HDD unit 30 as one of its components.

The host computer 10 includes hardware such as a CPU (processor), ROM, RAM, an I/O controller, a communication interface, a USB host interface, and a HDD. The host computer 10 also includes, as its function, a printer driver for controlling the printer device 20.

The printer driver is similar to common printer drivers. In other words, the printer driver, after receiving a print request from a user specifying the printer device 20 via an application program operating externally or in the host computer 10, creates a print job based on a predetermined printer control language that can be interpreted by the printer device 20, and sends the print job to the printer device 20 connected to the host computer 10.

The print job may contain, in its header, job information such as a job ID, output destination printer model information, a user name (user ID), a print target document file name, print setting information (number of print sets, designation of single-side/double-side printing, and designation of color/monochrome, etc.).

The configuration of the printer device 20 is similar to that of common printer devices.

For example, the printer device 20 includes a motor mechanism having a sheet feeder mechanism for feeding sheets to the printer device, a print engine for executing printing, and a sheet ejector mechanism for ejecting sheets from the printer device, etc. The print engine usually includes a paper feed, a carriage mechanism, and a print head, etc. Various types of print engine corresponding to serial printers that execute printing in units of characters such as inkjet printers and thermal transfer printers, line printers that execute printing in units of lines, and page printers that execute printing in units of pages can be used.

In addition, for example, the printer device 20 has an information processing unit including hardware such as a CPU, ROM, RAM (which may be nonvolatile RAM), user interfaces such as a console panel, a USB device interface, and an ATA compatible HDD unit connection interface (which may be a HDD host controller, or a connector, etc).

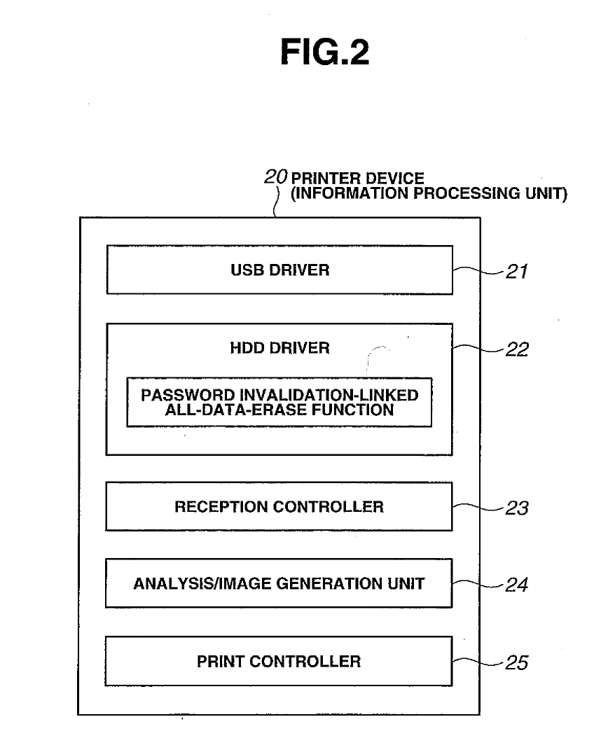

The information processing unit in the printer device 20 has the same functions as those in typical printer devices (see FIG. 2). For example, the information processing unit includes a USB driver 21 for controlling communication with the host computer 10 connected via the USB device interface, a HDD driver 22 for controlling access to the HDD unit 30 connected via the HDD unit connection interface, a reception controller 23 for receiving print jobs, commands, font data, or form data, etc., sent from the host computer 10 and storing it in the RAM or the HDD unit 30, an analysis/image generation unit 24 for generating, based on a print job and various kinds of data stored in the RAM or the HDD unit 30, raster print images for a band or a page and storing the raster print image in an image buffer, and a print controller 25 for transferring, based on a control command included in the print job, the print image for a predetermined unit (e.g. for a path) from the image buffer to the print engine and executing printing by controlling the print engine, etc.

Meanwhile, as shown in FIG. 2, the HDD driver 22 according to this embodiment differs from typical HDD drivers on the following points. As shown in FIG. 2, the HDD driver 22 has not only the regular HDD driver functions, but also a password invalidation-linked all-data-erase function for checking, when executing processing for erasing all data stored in the HDD unit 30, whether or not a password has been set for the HDD unit 30 and notifying the HDD unit 30 of the password, if set, to invalidate the password-type lock function.

Each of those units and drivers is functionally realized (implemented) by having the CPU execute programs stored in the ROM or RAM in the printer device 20, or an external storage medium.

The HDD unit 30 has such hardware as a connection interface, a controller, a HD and its drive mechanism, ROM, and RAM, and various functions like those included in typical ATA compatible HDD units.

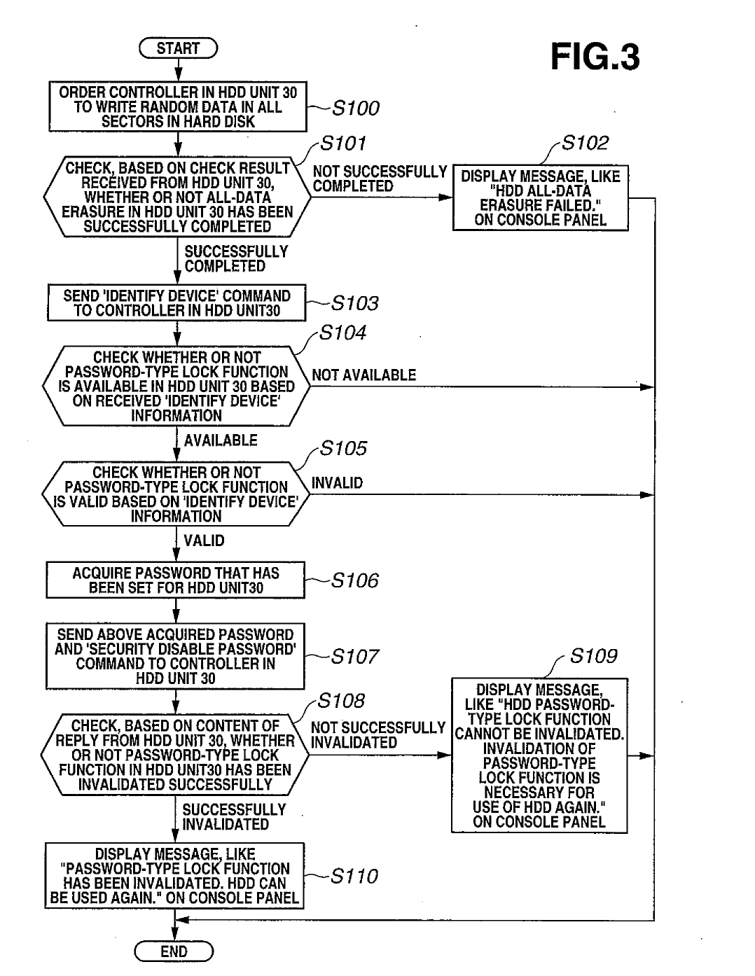

The all-data-erase processing performed in the HDD unit 30 in this embodiment will be described below with reference to the flowchart in FIG. 3 defining the operations in the printer device 20 (the HDD driver 22). The order of steps (including partial steps without reference numbers) may be modified arbitrarily, or several steps may be executed at a time, so long as the content of the processing does not become contradictory. Although the HDD driver 22 has various functions, explanations for those not directly related to the processing for erasing all data has been omitted.

When a user selects “HDD all-data-erase” in a menu screen presented on a console panel or similar in the printer device 20 to order execution of the processing, the HDD driver 22 executes the following all-data-erase processing.

The printer device 20 may be configured to present “HDD all-data-erase” in the menu screen to enable a user to select it only when the printer device 20 is started up in a special way or when the user can be identified as a particular person with a password or similar, or may be configured to request input of a password or similar to verify the user after “HDD all-data-erase” is selected, so that only particular people (for example, repair personnel or administrators) can select and execute “HDD all-data-erase.”

The HDD driver 22 orders the controller in the HOD unit 30 to write random data (or fixed data such as “00” or “FF”) in all sectors in the hard disk (S100).

The controller in the HDD unit 30, after receiving the order, writes random data, etc. in all sectors in the hard disk. After finishing the data write, the controller notifies the HDD driver 22 of a check result indicating whether or not the data write processing has been successfully completed.

The HDD driver 22, after receiving the check result from the HDD unit 30, checks, based on the received check result, whether or not the all data in the HDD unit 30 has been successfully erased (S101). More specifically, if the write processing has been successfully completed, the HDD driver 22 judges that all data has been successfully erased.

If the all data has not been successfully erased, the HDD driver 22 displays a message, like “HDD all-data-erasure failure.” on a console panel (S102), and terminates the all-data-erase processing.

Meanwhile, if the all data has been erased successfully, the HDD driver 22 sends an ‘Identify Device’ command to the controller in the HDD unit 30 (S103).

The controller in the HDD unit 30, after receiving the command, refers to the ROM or the nonvolatile RAM in the HDD unit 30 to read the serial number of the HDD unit 30 and the information concerning the password-type lock function (whether or not the lock function is available; if available, whether or not the function is valid; if valid, whether or not the access restricting status of lock function is read-protected, etc.), and sends, in reply to the command, the above read information as ‘Identify Device’ information to the HDD driver 22.

If the HDD driver 22 acquires the ‘Identify Device’ information from the HDD unit 30 and stores the ‘Identify Device’ information in the memory in the printer device 20 when the printer device 20 starts up, the HDD driver 22 may be configured to read that information from the memory in the printer device 20 instead of executing S103.

The HDD driver 22, after acquiring the ‘Identify Device’ information from the HDD unit 30, checks whether or not the password-type lock function is available in the HDD unit 30 based on the acquired information (S104).

If the password-type lock function is not available, the HDD driver 22 terminates the all-data-erase processing.

Meanwhile, if the password-type lock function is available, the HDD driver 22 checks, based on the ‘Identify Device’ information, whether or not the password-type lock function is invalid (S105).

If the password-type lock function is invalid, the HDD driver 22 terminates the all-data-erase processing.

Meanwhile, if the password-type lock function is valid, the HDD driver 22 acquires a password that has been set for the HDD unit 30 (S106).

How to acquire the password depends on how the password was decided on when it was set. If, for example, a user decided on the password, the password may be acquired from the user during the execution of the all-data-erase processing. Meanwhile, if the user decided on the password and then stored it in the nonvolatile RAM or similar in the printer device 20, the password may be acquired by referring to the nonvolatile RAM or similar. The password may be acquired in the same way even if the HDD driver 22 or similar automatically created the password based on random numbers, etc., since the password is stored in the nonvolatile memory or similar in that case too.

If the HDD driver 22 or similar automatically creates a password based on device information about the printer device 20 (for example, a manufacturer name, model name, or serial number, etc.) stored in a memory unit (ROM, or nonvolatile RAM or similar.) in the printer device 20, and sets/cancels the password-type lock by notifying the HDD unit of the thus created password, the password does not have to be stored in the nonvolatile RAM or similar. In that case, the same password may be created (acquired) again during the execution of the all-data-erase processing based on device information acquired by referring to the memory unit in the printer device 20.

Next, the HDD driver 22 sends the above acquired password and a ‘security disable password’ command to the controller in the HOD unit 30 (S107).

The controller in the HDD unit 30, after receiving the ‘security disable password’ command, checks whether or not the password received with that command matches the password stored in the nonvolatile RAM or similar in the HDD unit 30. If the passwords match, the controller in the HDD unit 30 invalidates the password-type lock function in the HDD unit 30. After the password-type lock function is invalidated, the access restriction status for the HDD unit 30 becomes, as the default value set when the HDD unit 30 is turned on or reset, the readable state. Next, the controller in the HDD unit 30 notifies, in reply to the command, the HDD driver 22 that the password-type lock function has been invalidated. Meanwhile, if the password-type lock function has not been invalidated successfully because the passwords do not match, or for some other reasons, the controller in the HDD unit 30 notifies, in reply to the command, the HDD driver 22 that the password-type lock function has not been invalidated successfully.

The HDD driver 22, after receiving the reply to the ‘security disable password’ command from the HDD unit 30, checks, based on the content of the reply, whether or not the password-type lock function in the HDD unit 30 has been invalidated successfully (S108).

If the password-type lock function has not been invalidated successfully, the HDD driver 22 displays a message, like “HDD password-type lock function cannot be invalidated. Invalidation of password-type lock function is necessary for use of HDD again.” on a console panel (S109), and terminates the all-data-erase processing.

Meanwhile, if the password-type lock function has been invalidated successfully, the HDD driver 22 displays a message, like “HOD password-type lock function in HDD has been invalidated. HDD can be used again.” on a console panel (S110), and terminates the all-data-erase processing.

If the password-type lock function is invalid, the access restriction status in the HDD unit 30 becomes, as the default value set when the HDD unit 30 is turned on or reset next, the readable state. Accordingly, the HDD driver 22 may send a reset command to the HDD unit 30 to immediately change the access restriction status in S110.

As described above, the printer device 20 (HDD driver 22) according to this embodiment has the password invalidation-linked all-data-erase function for checking, when executing the processing for erasing all data stored in the HDD unit 30, whether or not a password has been set for the HDD unit 30, and invalidating, if a password has been set, the password-type lock function by notifying the HDD unit 30 of the set password. Therefore, a user can automatically change the status of the HDD unit 30 so that it can also be used in another electronic device (i.e., the password-type lock function is invalidated) simply by ordering erasure of all data in the HDD unit 30, without invalidating the password-type lock function by using the BIOS, etc.

With the printer device 20 in particular, the possibility of its storing highly confidential and valuable data such as print data, font data, and form data in the HDD unit 30 is very high, so password setting for the HDD unit 30 is essential; however, the HDD unit 30 may also be used in other electronic device, and as a result the invention is highly advantageous.

When the printer device 20 erases all data stored in the HDD unit 30, the printer device 20 checks, after the execution of the all-data-erase processing, whether or not a password has been set for the HDD unit 30, and invalidates, if a password has been set, the password-type lock function by notifying the HDD unit 30 of the set password. Accordingly, if the all-data-erase processing cannot be completed because the device turns off during the execution of the all-data-erase processing, or for some other reason, if the password-type lock function for the HDD unit 30 has been set to valid, that setting will remain unchanged.

### MODIFIED EXAMPLE

The invention is not limited to the above embodiment, but may be modified in various ways. For example, the host computer 10 and the printer device 20 may be connected according to any standard (protocol) other than USB.

In the above embodiment, a printer device is used as an electronic device. However, the invention can also be used in copy machines, facsimiles, and complex machines, etc. In the case of a facsimile, it is possible that highly confidential data, such as client's telephone directory, is stored in a HDD unit 30. Therefore, a great advantage can be obtained by using the invention.

Part of, or the entire HDD driver 22 may be realized by hardware, or may be realized as a function of an OS or BIOS mounted on an electronic device.

Although in the above embodiment the all-data-erase processing is executed by writing random data or similar to all sectors in the hard disk, random data or similar may be written not to all sectors, but only to some sectors, and at random, to prevent recovery of the original data.

In the above embodiment, the password-type lock function invalidation processing is executed after the execution of the all-data-erase processing. However, if “HDD-all-erase” is selected, the processing for erasing all data stored in the HDD unit may be executed after executing the password-type lock function invalidation processing.

In the above embodiment and modified example, a HDD unit is used as an example of a storage unit. However, any other large-capacity nonvolatile storage unit, such as USB memory, a memory card, or a DVD, etc., that can be attached to electronic devices, can be used in the invention.

What is claimed is:

1. A storage driver for controlling access to a storage unit having a password-type lock function, wherein the storage driver checks, when executing processing for erasing all data stored in the storage unit, whether or not a password has been set for the storage unit, and invalidates the password-type lock function if a password has been set.

2. The storage driver according to claim 1, wherein the storage driver invalidates the password-type lock function after notifying the storage unit of the set password.

3. An electronic device including the storage driver according to claim 1, comprising;
a memory unit for storing device information about the electronic device,
wherein the storage driver creates a password based on the device information acquired by referring to the memory unit, and sets/cancels the password-type lock or invalidates the password-type lock function by notifying the storage unit of the created password.

4. An access control method for a storage unit having a password-type lock function, the method comprising:
checking, when executing processing for erasing all data stored in the storage unit, whether or not a password has been set for the storage unit, and
invalidating the password-type lock function if a password has been set.

5. A program for executing the access control method according to claim 4 in a computer.
